(19) United States
(12) Patent Application Publication
(10) Pub. No.: US 2022/0295692 A1
(43) Pub. Date: Sep. 22, 2022

(54) MANIFOLD ASSEMBLY

(71) Applicant: Ag Premier, Inc., Iowa Falls, IA (US)

(72) Inventor: Mick Zoske, Iowa Falls, IA (US)

(21) Appl. No.: 17/696,209

(22) Filed: Mar. 16, 2022

Related U.S. Application Data
(60) Provisional application No. 63/162,668, filed on Mar. 18, 2021.

(51) Int. Cl. A01C 23/00; F16L 41/03

(52) U.S. Cl. CPC A01C 23/002; F16L 41/03

(57) ABSTRACT

Disclosed is a nonlimiting example of a manifold assembly. In example embodiments the manifold assembly may include a manifold bowl, a manifold cover over the manifold bowl, a manifold plate having a plurality of holes, a restraint structure configured to prevent the manifold plate from translating and overturning, and an actuator configured to rotate the manifold plate. In one nonlimiting example embodiment the manifold cover has a plurality of holes and a plurality of hose barbs aligned with the plurality of holes. In this nonlimiting example embodiment the plurality of holes in the manifold plate are alignable with the plurality of holes in the manifold cover. In at least one nonlimiting example embodiment, rotating the manifold plate aligns and misaligns the holes in the manifold plate and the holes in the manifold cover.

### CROSS-REFERENCE TO RELATED APPLICATIONS

This application claims the benefit of U.S. Provisional Patent Application No. 63/162,668 which was filed with United States Patent and Trademark Office on Mar. 18, 2021, the entire contents of which are herein incorporated by reference.

### BACKGROUND

### 1. Field

Example embodiments relate to a manifold assembly. In one nonlimiting example embodiment, the manifold assembly may be used as part of a liquid manure application system.

### 2. Description of the Related Art

Liquid manure systems use manifolds to distribute liquid manure to various row units. Generally speaking, the manure runs from a manifold to the row units via a plurality of hoses. Ideally, manifolds distribute manure through each hose evenly to promote an even application of manure to the ground. When flow is not even, some crops receive too much manure while other crops receive too little. Crops that get too much manure might have a slight bump in growth and yield but the crops having too little manure are stunted which causes an overall reduction in total yield.

To obtain an even distribution of manure, manifolds must obtain a certain internal pressure to push an even amount of liquid out of various ports of the manifold. Low internal pressure may result in manure flowing out of only a few ports in the manifold while other ports have little or no flow of liquid manure. As technology in the industry has improved operators can now pump more gallons of liquid manure per minute and use wider toolbars. Wider toolbars require more manure and manifolds have been designed to accommodate the manure. A problem, however, is that manifolds designed for even flow at high gallons per minute perform poorly when the flow is relatively low. This may happen when: 1) manure becomes thick as the pit level is lowered; 2) a low application rate is required (gallons/acre), and 3) the operator cannot pull the toolbar fast enough to keep the gallons per minute up. For example, an operator can be set up in a hog facility. When an operator starts pumping, the operator may achieve 2,500 GPM, a flow at which most manifolds flow well. However, as the pit level drops to the last couple feet, the manure can become so thick that the operator might only be able to pump 900-1,000 GPM. At these lower flow rates a manifold designed for 2500 GPM will not perform well. That is, liquid manure will not flow even out of the manifold and across the toolbar at 900-1000 GPM due to low or no internal pressure in the manifold.

Another example is an applicator can be pumping at a dairy farm where he/she can apply 20,000 gallons per acre and can pump 3,500 GPM but the next job is a hog finishing site where the application rate is 3,000 GPA. In this case, the toolbar and hose can only be pulled so fast so at the hog facility they are forced to slow their flow down to 1,800 gallons per minute and cause the manifold not to perform as required.

Trash in the manure is also a problem in that it may cause a manifold to plug.

### SUMMARY

With the above problems in mind, the inventor set out to design a new manifold which reduces, if not eliminates, the above problems. The inventor's manifold is designed for high flow rates but can be quickly/easily adjusted for the lower flow rate and low internal pressures. In one nonlimiting example embodiment, an electric pressure transducer may detect pressure in the manifold and send a signal to a digital readout in the tractor cab. In this example, the operator can monitor and adjust the pressure in the manifold in real time. Applicant also invented a manifold plate that can be rotated with an actuator, for example, an electric actuator, and controlled from the cab. The manifold plate opens and restricts each port out of the manifold to maintain a desired pressure in the manifold to keep the flow equal to each port. Such features are incredibly useful. For example, an operator may prefer 5 PSI in the manifold for even flow across the bar. When an operator is pumping a higher flow, the operator can simply rotate the manifold plate allowing more flow out of the manifold while maintaining a pressure of 5 PSI. As the pit level lowers and the manure becomes thicker the manifold may drop to say 2 PSI, without any adjustments this causes the flow to become very uneven. With the inventor's manifold the operator can rotate the manifold plate while on the go until the desired pressure in the manifold, for example, 5 PSI, is reached again. As flow rates keep dropping till the job is finished, the operator can keep rotating the manifold plate to maintain a pressure of 5 PSI. If the operator's next job is a dairy farm with high flow, the operator can simply rotate the manifold plate from the seat of the tractor to maintain the 5 PSI at a higher flow rate. This set up allows the operator to maintain even flow across a wide range of flow rates, for example, from 4,000 GPM to 600 GPM. This feature will help both the dragline and tank industries in keeping even nutrient application for the next crop.

In addition, the inventor has incorporated knife system in the manifold. The knife system spins hydraulically and will cut debris as it passes through the manifold plate sizing it so it will pass through the manifold ports. The knife system has an auto reverse kit on it so if a knife stops against debris it automatically switches direction to hit the debris from the other side. The knife will keep doing this until the debris is cut to size or knocked out of the manifold plate and it drops to the bottom of the manifold.

As will be clear from the detailed description, example embodiments relate to a manifold assembly. In example embodiments, the manifold assembly may be part of a manure application system.

Disclosed is a nonlimiting example of a manifold assembly. In example embodiments the manifold assembly may include a manifold bowl, a manifold cover over the manifold bowl, a manifold plate having a plurality of holes, a restraint structure configured to prevent the manifold plate from translating and overturning, and an actuator configured to rotate the manifold plate. In one nonlimting example embodiment the manifold cover has a plurality of holes and a plurality of hose barbs aligned with the plurality of holes. In this nonlimiting example embodiment, the plurality of holes in the manifold plate are alignable with the plurality of holes in the manifold cover. In at least one nonlimiting example embodiment, rotating the manifold plate aligns and misaligns the holes in the manifold plate and the holes in the manifold cover.

Disclosed is another example of a manifold assembly. In example embodiments, the manifold assembly may include a manifold bowl having an opening to receive a material, a manifold cover over the manifold bowl (the manifold cover having a plurality of holes to flow the material out of the manifold cover), a manifold plate having a plurality of holes corresponding to the plurality of holes in the manifold cover, a restraint structure configured to prevent the manifold plate from translating and overturning, and an actuator configured to rotate the manifold plate. In this nonlimiting example embodiment rotating the manifold plate aligns and misaligns the holes in the manifold plate with the holes in the manifold cover to adjust a pressure in the manifold assembly.

Disclosed is another example of a manifold assembly. In example embodiments, the manifold assembly may include a vessel having an inlet and a plurality of outlets, a manifold plate having a plurality of holes alignable with plurality of outlets, one or more restraint members configured to prevent the manifold plate from translating, a pressure sensor configured sense a pressure in the vessel, and an actuator configured to rotate the manifold plate to one of decrease and increase pressure in the vessel.

### BRIEF DESCRIPTION OF THE DRAWINGS

Example embodiments are described in detail below with reference to the attached drawing figures, wherein:

FIG. 1 is a perspective view of a manifold assembly in accordance with example embodiments;

FIG. 2 is a perspective view of a top of a manifold assembly in accordance with example embodiments;

FIG. 3 is a side view of a manifold assembly in accordance with example embodiments;

FIG. 4 is a top view of a top of a manifold assembly in accordance with example embodiments;

FIG. 5 is a bottom view of a manifold assembly in accordance with example embodiments;

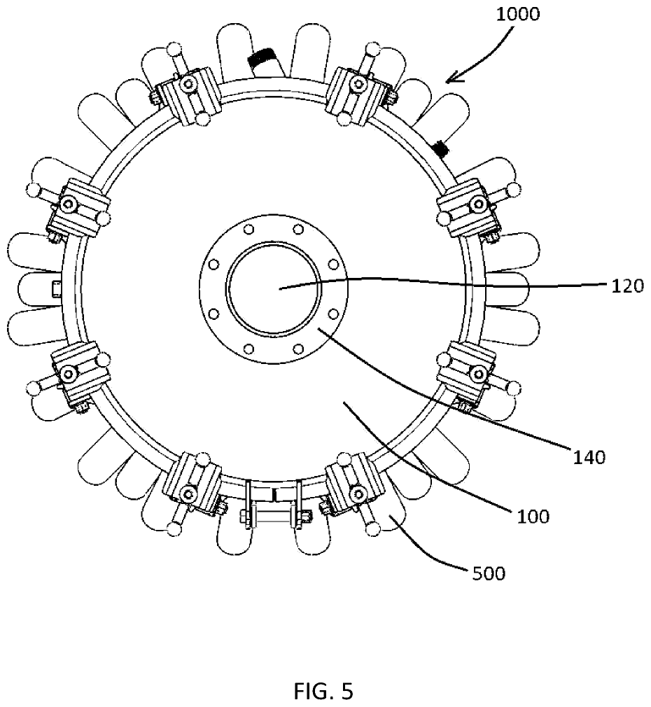

FIG. 6 is a front side view of a manifold assembly in accordance with example embodiments, wherein a manifold cover is tilted upwards;

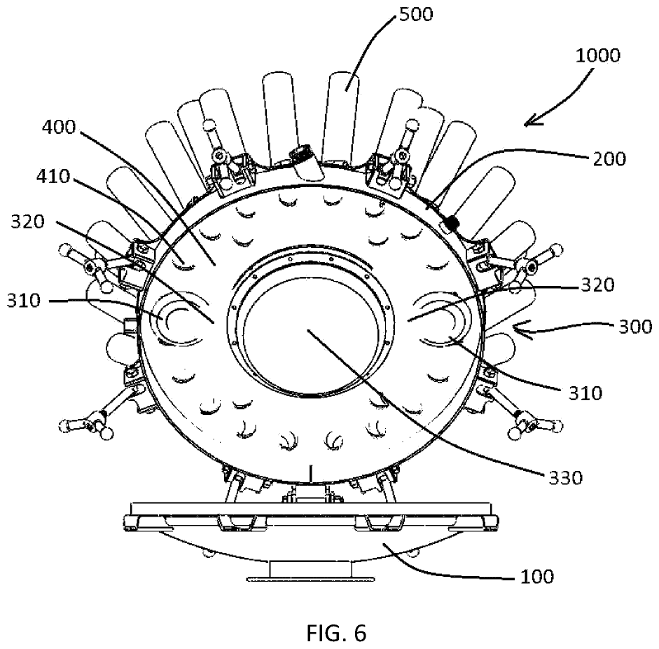

FIG. 7 is a back side view of a manifold assembly in accordance with example embodiments, wherein a manifold cover is tilted upwards;

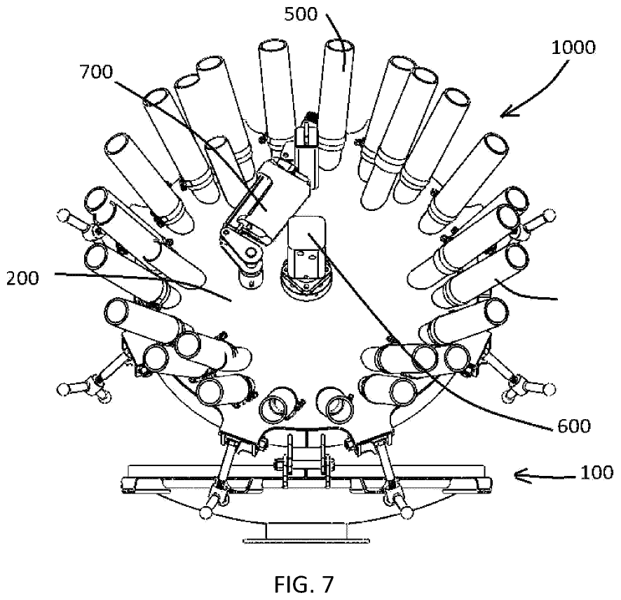

FIG. 8 is a first section view of a manifold assembly in accordance with example embodiments;

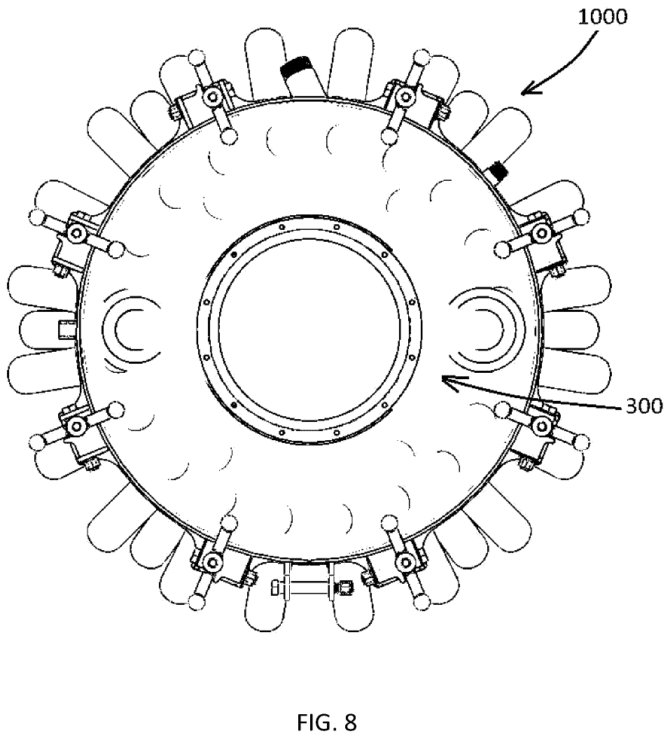

FIG. 9 is a second section view of a manifold assembly in accordance with example embodiments; and

FIG. 10 is a third section view of a manifold assembly in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a manifold assembly.

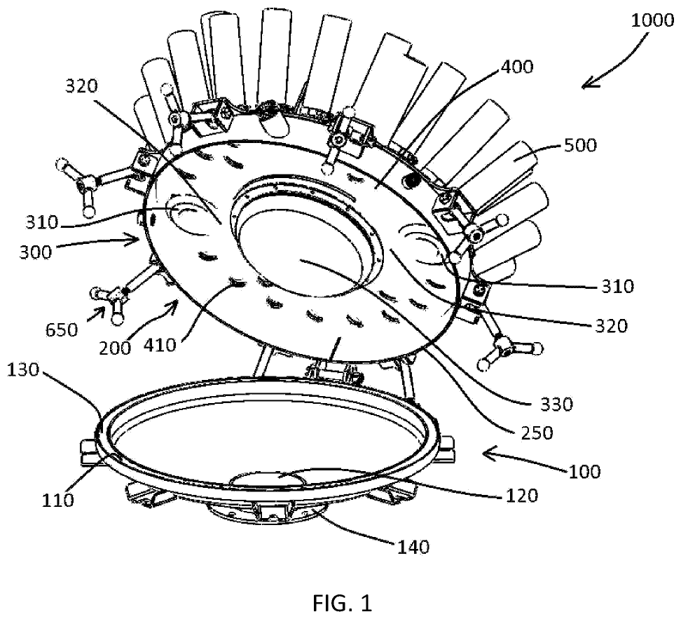

FIG. 1 is a view of a manifold assembly 1000 in accordance with example embodiments. As shown in FIG. 1, the manifold assembly 1000 may be comprised of a manifold bowl 100 and a manifold cover 200. In the nonlimiting example of FIG. 1, the manifold bowl 100 may be connected to the manifold cover 200 via a hinge allowing the manifold cover 200 to pivotally raise to expose the inside of the manifold assembly 1000. This aspect of example embodiments, however, is not meant to limit the invention. For example, rather than using a hinge to connect the manifold bowl 100 to the manifold cover 200 the manifold 100 may be clamped to the manifold cover 200 allowing the manifold cover 200 to be completely separated from the manifold bowl 100.

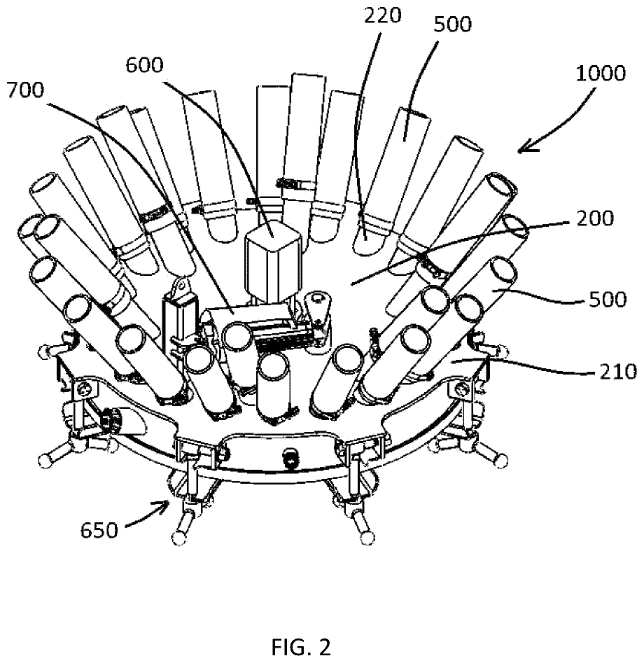

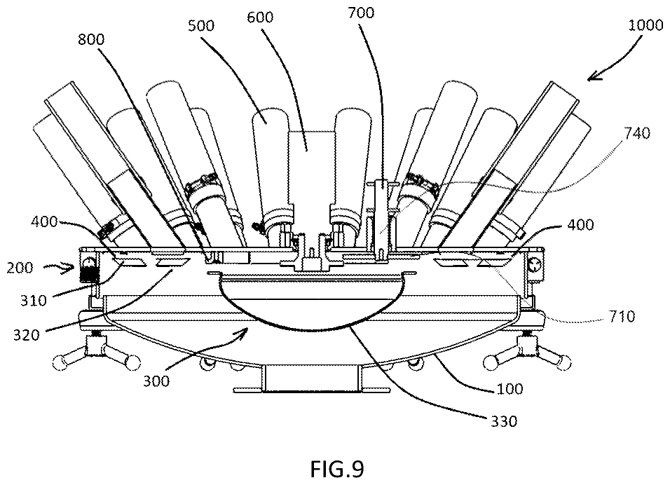

In example embodiments, the manifold assembly 1000 may include a cutting apparatus 300 substantially enclosed by the manifold bowl 100 and the manifold cover 200. The cutting apparatus 300 may include one or more blades 310 operatively connected to a motor 600 (see FIG. 2), for example, a hydraulic motor, by one or more arms 320. In operation, the blades 310 revolve within the manifold assembly 1000 to cut up or reduce the size of objects that may be therein as the motor 600 is operated. In the nonlimiting example of FIG. 1, the cutting apparatus 300 further includes an impact surface 330 upon which a material, for example, manure, may be impact. In the nonlimiting example of FIG. 1 (and as better shown in FIG. 9) the impact surface 330 may be not flat and/or may be configured to direct a material, for example, manure to the sides of the manifold assembly 1000. As shown in the figures, the impact surface 330 may be dome shaped but may have another type of surface, for example, a surface that resembles a pyramid or cone to direct material flow sideways. Having an impact surface 330 configured to direct material sideways may help material flow within the manifold assembly 1000 during operation. It is understood that while the above description describes the impact surface 330 as being part of the cutting apparatus 300, this is not intended to limit the invention. For example, in another embodiment, the impact surface 330 is not part of the cutting apparatus 300 but is supported over an inlet 120 of the manifold bowl 100 by support members such as beams, or struts.

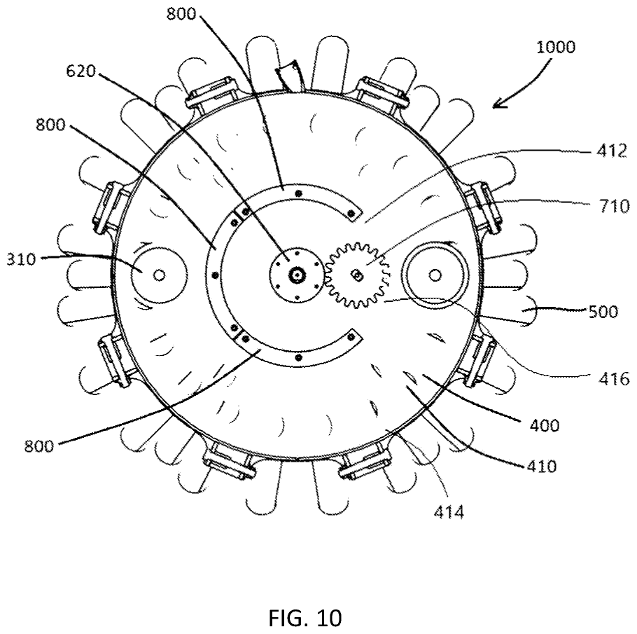

In example embodiments, the motor 600 may be attached to an outside surface of the manifold cover 200 as shown in at least FIG. 2. In one nonlimiting example embodiment the motor 600 includes a shaft that penetrates the manifold cover 200 and extends to a plate 620 (see FIG. 10) that may be bolted, or otherwise attached to, the cutting apparatus 300. Thus, as the shaft of the motor turns the arms 320 of the cutting apparatus 300 turn to move the blades 310 inside the manifold assembly 1000. In one nonlimiting example embodiment the blades 310 will cut debris as it turns sizing it so it will pass through the manifold ports of the manifold assembly. The cutting apparatus 300, in one embodiment, may have an auto reverse kit so if a blade 310 stops against debris the motor 600 automatically switches direction so the blade 310 can hit the debris from the other side. The blades 310 will keep doing this until the debris is cut to a size allowing the debris to pass out of the manifold assembly 1000 or knocked free from the manifold plate.

In example embodiments the manifold cover 200 may have a top 210 (see FIG. 2) with a plurality of holes associated with a plurality of hose barbs 220 which may also be referred to as manifold ports. The hose barbs 220 may resemble short cylindrical pipes through which material may flow out of the manifold assembly 1000. The hose barbs 220 may serve as connection points to a plurality of hoses 500 which may deliver material to a location where the material is to be applied. For example, the manifold assembly 1000 may deliver a material, for example, manure, to a plurality of row units associated with a tool bar.

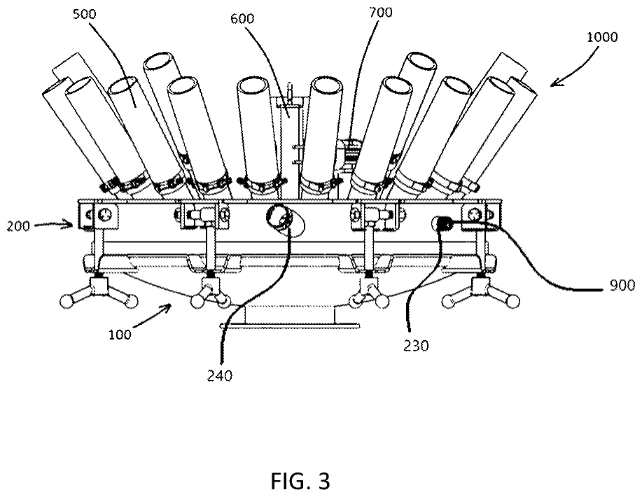

Thus far, the manifold assembly 1000 of FIG. 1 is described as having a manifold bowl 100, a manifold cover 200 and a cutting apparatus 300 between the manifold bowl 100 and the manifold cover 200. In use the manifold cover 200 is closed on top of the manifold bowl 100 as shown in FIG. 3. In addition, one or more clamps 650 may be used to clamp the manifold cover 200 to the manifold bowl 100 and a gasket 130 may be provided in a receiving space 110 of the manifold bowl 100 to ensure material flowing into the manifold assembly 1000 will not flow out of the manifold assembly 1000 where the manifold cover 200 interfaces with the manifold bowl 100.

In general, material, for example, manure, may enter the manifold assembly 1000 through an opening 120 provided in the manifold bowl 100. The material flowing into the manifold bowl 100 may impact the impact surface 330 of the manifold assembly 1000 and spread sideways. As the material continues to flow in, the material may leave the manifold assembly 1000 through the hose barbs 220 and hoses 500. Any solids that may be present in the material may be reduced in size through operation of the motor 600 which causes the blades 310 to revolve inside the manifold assembly 1000. Cutting apparatus 300 helps ensure material will flow more evenly out of the manifold assembly 1000 and prevents blockage of the hose barbs 220.

The manifold assembly 1000 of FIG. 1 includes additional inventive features. For example, as shown in FIG. 1, the manifold assembly 1000 further includes a manifold plate 400. The manifold plate 400 includes a plurality of apertures 410 which correspond with the plurality of holes in the manifold cover 200 associated with the hose barbs 220. The manifold plate 400 may be rotationally supported within the manifold assembly 1000 so that the holes 410 in the manifold plate may be aligned with the holes in the manifold cover 200 where the hose barbs 220 are located. When fully aligned, material, for example, manure, may flow out of the manifold assembly 1000 through the holes in the manifold cover 200 associated with the hose barbs 220. However, the manifold plate 400 may be rotated so the holes 410 of the manifold plate 400 are not aligned with the holes in the cover 200 corresponding the hose barbs 220 thus severely restricting if not eliminating flow of material out of the manifold assembly 1000.

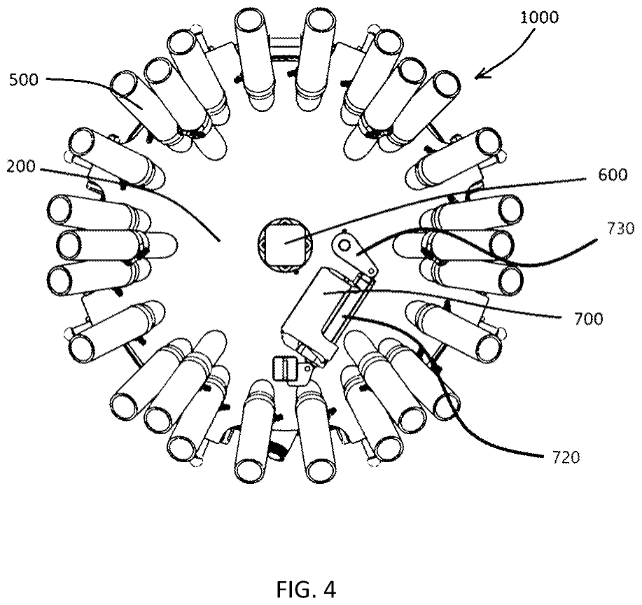

In example embodiments the manifold plate 400 may be supported a number of ways so as to be rotatable in the manifold assembly 1000. For example, in one nonlimiting example embodiment, the manifold plate 400 may resemble an annulus having an inner radius 412 and an outer radius 414. The manifold plate 400 may be supported on its inner radius 412 by one or more plates 800 having an L-shaped cross section. The plates 800 may prevent the manifold plate 400 from substantially translating or overturning but does not prevent the plate 400 from rotating within the manifold assembly 1000. Thus, in this nonlimiting example embodiment, plates 800 acts as restraint structures to restrain the manifold plate 400. The inner radius 412 may have teeth 416 configured to mesh with a gear 710 of an actuator 700 so that as gear 710 turns the manifold plate 400 is rotated. In the nonlimiting example embodiments, the actuator 700 may include a linear actuator 720 (see at least FIG. 4) that connects to a lever arm 730 which in turn connects to a shaft 740 (see at least FIG. 9) that penetrates the manifold cover 200 and connects to the gear 710 (see at least FIGS. 9 and 10). Thus, as the linear actuator 720 extends or retracts, the lever arm 730 is rotated to rotate the shaft 740 which rotates the gear 710.

In example embodiments the actuator 700 may be controlled so the apertures 410 of the manifold plate 400 are substantially aligned with the plurality of holes associated with the hose barbs 220. On the other hand, the actuator 700 may be controlled so the apertures 410 of the manifold plate 400 are substantially misaligned with the plurality of holes associated with the hose barbs 220. In this latter position the manifold plate 400 would prevent material from passing through the plurality of holes associated with the hose barbs 220. Of course, the actuator 700 may be controlled so the apertures 410 of the manifold plate are partially aligned with the plurality of holes associated with the hose barbs 220. Thus, the amount of material flowing out of the manifold assembly 1000 may be controlled by controlling the manifold plate 400.

As one skilled in the art will appreciate, pressure within the manifold assembly 1000 may be controlled by controlling the manifold plate 400. Pressure, for example, may be increased by misaligning the apertures 410 of the manifold plate 400 with the plurality of holes associated with the hose barbs 220 and reduced by aligning the apertures 410 of the manifold plate 400 with the plurality of holes associated with the hose barbs 220. To this end, example embodiments anticipate an operator be able to control the actuator 700 either over a wire or wirelessly. Furthermore, the operator may be able to control the pressure within the manifold assembly 1000 by using a pressure/sensor 900 which may be arranged in a first nipple 230 of the manifold cover 200. The pressure/sensor 900, for example, a transducer, may sense pressure in the manifold assembly 1000 and send data to the operator. In response, the operator may control the actuator 700 to rotate the manifold plate 400 thereby adjusting the pressure in the manifold assembly 1000. In addition, example embodiments also anticipate a control system wherein data from the pressure/sensor 900 is received by a computer which uses this data to automatically control pressure in the manifold assembly 1000 by automatically controlling the actuator 700.

Example embodiments are envisioned to include additional elements not yet described. For example, as shown in FIG. 3 the manifold cover 200 may include a second nipple 240 which may house or otherwise be associated with a safety device such as a pressure relief valve in order to prevent the manifold assembly 1000 from building up too much pressure.

In operation the manifold assembly 1000 may be in a closed state where the manifold cover 200 is latched to the manifold bowl 100 by a series of latches 650. In this state, an end 250 of the manifold cover 200 may be inserted into a receiving space 110 of the manifold bowel 100 as shown in at least FIG. 3. In the closed state a material, for example, manure, may flow into the manifold bowl via a flange 140 and opening 110 which may be at the bottom of the manifold bowl 100. The material may flow against the impact surface 330 and disperse within the bowl 100 and cover 200 of the manifold assembly 1000. The material may then flow out of the manifold assembly 1000 via the apertures 410 of the manifold plate 400 and the apertures in the cover 200 associated with the hose barbs 220. During these operations, a pressure within the manifold assembly 1000 may be monitored by pressure/sensor 900 and the pressure within the assembly 1000 may be controlled by controlling the actuator 700 which rotates the manifold plate 400 until a desired pressure is reached. Simultaneously, the motor 600 may be operated to rotate the blades 310 of the cutting apparatus 300 to ensure any large pieces of material are reduced in size to promote flow of the material through the manifold assembly 1000.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A manifold assembly (1000) comprising:
a manifold bowl (100) having an opening (120) to receive a material;
a manifold cover (200) over the manifold bowl (100), the manifold cover (200) having a plurality of holes and a plurality of hose barbs (220) aligned with the plurality of holes, the hose barbs (220) being configured to flow the material to a plurality of hoses (500);
a manifold plate (400) having a plurality of holes (410) corresponding to the plurality of holes in the manifold cover (200);
at least one restraint structure (800) configured to prevent the manifold plate (400) from translating and overturning; and
an actuator (700) configured to rotate the manifold plate (400), wherein rotating the manifold plate (400) aligns and misaligns the holes (410) in the manifold plate (400) and the holes in the manifold cover (200).

2. The manifold assembly of claim 1, further comprising:
a cutting apparatus between the manifold bowl and the manifold cover; and
a motor configured to rotate the cutting apparatus.

3. The manifold assembly of claim 2, wherein the cutting apparatus includes at least one blade to cut apart the material.

4. The manifold assembly of claim 2, wherein the motor is a hydraulic motor.

5. The manifold assembly of claim 1, further comprising:
a non-flat impact surface configured to disperse material to sides of the manifold assembly.

6. The manifold assembly of claim 1, wherein the manifold cover and the manifold bowl are connected to one another by a hinge.

7. The manifold assembly of claim 1, further comprising:
a pressure sensor configured to sense pressure within the manifold assembly.

8. The manifold assembly of claim 1, wherein the material is manure.

9. A tool bar comprising:
a plurality of row units;
the manifold assembly of claim 1; and
a plurality of hoses connecting the plurality of hose barbs to the plurality of row units.

10. A manifold assembly comprising:
a vessel having an inlet and a plurality of outlets;
a manifold plate having a plurality of holes alignable with plurality of outlets;
one or more restraint members configured to prevent the manifold plate from translating;
a pressure sensor configured sense a pressure in the vessel; and
an actuator configured to rotate the manifold plate to one of decrease and increase pressure in the vessel.

11. The manifold assembly of claim 10, further comprising:
a plurality of hose barbs associated with the plurality of outlets.

12. The manifold assembly of claim 10, wherein the vessel is comprised of a first member having the inlet and a second member having the plurality of outlets.

13. The manifold assembly of claim 12, wherein the first member is a manifold bowl and the second member is a manifold cover.

14. The manifold assembly of claim 10, further comprising:
a cutting apparatus in the vessel having at least one blade configured to revolve in the vessel.

15. The manifold assembly of claim 10, further comprising:
an impact surface.

16. The manifold assembly of claim 15, wherein the impact surface is non-flat.

17. A manure application system comprising:
a tool bar comprising a plurality of row units;
the manifold assembly of claim 10; and
a plurality of hoses configured to deliver manure from the assembly to the plurality of row units.

18. The manure application system of claim 17, wherein the vessel includes a plurality of barbs interfacing with the plurality of hoses.

19. The manure application system of claim 17, further comprising:
a cutting apparatus in the vessel having at least one blade configured to revolve in the vessel and cut up objects in the manure.

20. The manure application system of claim 17, further comprising:
a nonflat impact surface.
